(19) United States
(12) Patent Application Publication
(10) Pub. No.: US 2011/0058922 A1
(43) Pub. Date: Mar. 10, 2011

(54) TRUCK LOADING SYSTEM

(76) Inventor: MICHELE AURIEMMA, Bakersfiled, CA (US)

(21) Appl. No.: 12/872,940

(22) Filed: Aug. 31, 2010

Related U.S. Application Data
(60) Provisional application No. 61/276,014, filed on Sep. 8, 2009.

(51) Int. Cl. B65G 67/04

(52) U.S. Cl. 414/400; 414/809

(57) ABSTRACT

A system and method for loading solid state materials into shipping containers including trucking containers is disclosed. The system includes a movable frame having walls extending therealong and a trolley incorporated to the movable frame for receiving solid state materials. The system further includes two self moving parts, a pair of pusher rods and a basket system incorporated to the trolley. The at least one trolley and the at least one frame may be moved by way of at least one electric motor. The system is configured to load solid state materials quickly and efficiently by way of an automated roller-tracked bucket mechanism.

### CROSS-REFERENCE TO RELATED APPLICATION:

Applicant claims the priority filing date of Provisional Patent Application No. 61/276,014 filed on Sep. 8, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to systems for loading materials into shipping, including trucking, containers, and more particularly to a system designed for loading commercial containers with solid state materials in an easy, efficient manner, with great precision.

The use of various systems for loading materials into shipping containers has resulted in improved time management, efficiency and precision. The conventional systems for loading materials into shipping containers are time-consuming, manpower-intensive and machine-intensive. Several types of systems have been developed in the art for loading materials into shipping containers.

U.S. Pat. No. 6,616,103 issued to Marrero describes a cargo container apparatus and methods of loading cargo. The cargo container apparatus includes a cargo container having first and second opposing side frame portions joined by connecting members and a plurality of liners forming floor and wall portions of the cargo container. The apparatus also includes a cargo container transporter having a base portion, an elevating platform, a pair of side support rails, and front and rear ramps. Methods of transporting in a cargo hold are also provided. The methods include expanding a cargo container from a collapsed position; connecting a liner to a lower portion of the expanded container to form a floor; and loading cargo into the expanded cargo container.

U.S. Pat. No. 5,378,105 issued to Palko describes a cargo handling and restraining system for loading, unloading, and transporting cargo containers in a carrier vehicle. The carrier is provided with a supporting floor (bed) containing a plurality of tracks. The tracks include a channel between a pair of spaced, horizontally extending members and each container is provided with members which “ride” in the channel of the tracks to move the containers along the track. A hook assembly is provided at opposite ends and on the bottom of the containers to engage with a retaining mechanism which positively locks adjacent containers together and to the track. A locking member is provided for rigidly securing the last loaded container (toward the rear of the bed) to the track. A cargo loader mechanism is provided to load and unload the cargo onto and off of the bed, and a cargo cart is provided to transport the cargo to or from a storage bin.

U.S. Pat. No. 4,231,695 issued to Weston, Sr. describes an apparatus that includes a plurality of interconnected portable pallets on which cargo is placed and which may be selectively moved into or removed from a truck body. The pallets constitute the bed or floor of the truck and may be independently or simultaneously moved into or out of the body of the truck so that portions of the contents may be loaded or discharged from different loading docks; or the entire contents of the truck may be loaded or discharged from the same dock. The cargo may be loaded on the pallet or pallets prior to insertion into the body of the truck and such cargo may be unloaded from the pallets after the truck has departed so as to reduce delay in the operation of the truck.

Most of these systems for loading materials into shipping containers described herein are complex and not user-friendly. Some of these systems are not adapted to properly load the materials into containers to meet the weight distribution criteria recommended by the department of transportation (DOT). Moreover, some of these systems utilize a motorized rectangular storage container including hydraulic cylinders and scrap metals. These systems require a tremendous amount of torque to discharge the scrap metals into the ocean freight container thereby resulting in inefficient and uneconomic systems.

It is therefore, an object of the present invention to provide a simple, flexible, efficient, precise, and user-friendly system for loading materials into shipping containers. Another object of the present invention is to provide a system that may be adapted to properly load the materials into containers to meet the weight distribution criteria recommended by the department of transportation (DOT). Yet another object of the present invention is to provide a system that utilizes a minimum amount of torque to load materials into shipping containers thereby providing efficient and economic systems. Other objects of the present invention will become better understood with reference to the appended Summary, Description and Claims.

### SUMMARY

The present invention is a system and method for loading solid state materials into shipping containers, commercial containers, and trucks. The system includes a movable frame having walls extending therealong and a trolley positioned on top of the movable frame for receiving solid state materials. The system further includes two self moving parts, a pair of pusher rods and a basket system incorporated to the trolley. The movable trolley is designed for being placed on the movable frame that is adapted for being positionable at a loading position. The system is configured to load solid state materials quickly and efficiently by way of an automated roller-tracked bucket mechanism.

The trolley and the movable frame may be moved by way of an electric motor. The self moving part includes an axle coupled to a pair of traction wheels. The self moving part may be operated by way of the electric motor. The electric motor may be powered by way of electric current, batteries and the like. The electric current may be controlled by remote controllers. The pair of pusher rods may include at least one tube welded together through a bar for providing stability. The basket system includes a cradle welded to an axle through a small rod. The cradle includes a basket. The pair of pusher rods may be designed to interconnect the self moving part and the basket system by way of an axle bearing.

A method for loading solid state materials into shipping and trucking containers is initiated in the first step by placing the system for loading solid state materials onto a platform that can elevate the system to a level where it can be rolled into a shipping or trucking container. Load the cradle with solid state materials, such as scrap metal, rocks, stones, bags filled with potatoes, etc, or place a basket into the cradle then load the basket with solid state materials. Move the system for loading solid state materials inside the container. Push the trolley forward until it is stopped by a wheel stop block, then continue pushing the trolley until it tilts over and its contents fall out into the container. Return the trolley back to its stationery position and push it backwards so that it reaches the outside of the container for re-loading. If necessary, the entire system can be moved backwards so that the trolley is outside the container and the cradle can be reloaded. Then repeat this process.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a perspective view of the present invention, illustrating a system for loading solid state materials into shipping containers.

FIG. 2 is a perspective view of the present invention, illustrating a trolley with a movable container device having walls extending therealong.

FIG. 3 is a partial side sectional view of the present invention, illustrating a movable trolley designed for being placed on a movable frame.

FIG. 4 is a top plan view and partial sectional view of the present invention, illustrating the movable trolley.

FIG. 5 is a top plan view and partial sectional view of the present invention in a folded position, illustrating the movable trolley placed on the movable frame.

FIG. 6 is a side view of the present invention, illustrating a method for loading solid state materials into shipping containers.

### REFERENCE NUMERALS

10 . . . A system for loading solid state materials into shipping, including trucking, containers

14 . . . Walls

18 . . . At least one movable frame

20 . . . At least one trolley

22 . . . A pair of traction wheels

24 . . . Cradle wheels

26 . . . A first axle

28 . . . A pair of pusher rods

30 . . . At least one axle bearings

32 . . . A second axle

34 . . . At least one cradle

34a . . . Cradel rods

36 . . . At least one motor

40 . . . A measurement system

42 . . . At least one basket

44 . . . A wheel stop block

48 . . . A stability bar

50 . . . A method for loading solid state materials into shipping containers

### DETAILED DESCRIPTION

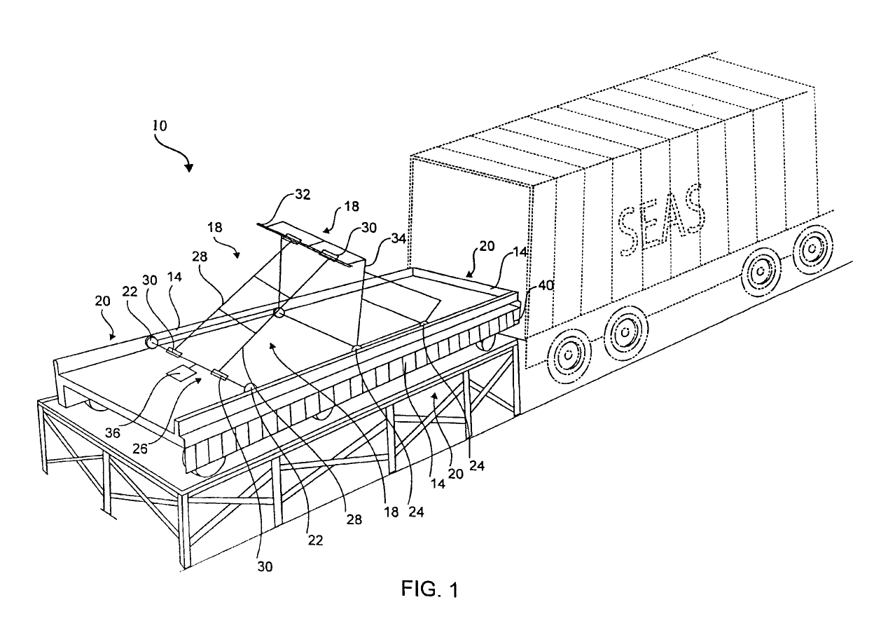

Referring to the drawings, a preferred embodiment illustrates a system 10 and a method 50 for loading solid state materials into shipping containers and generally indicated in FIGS. 1 through 3. Referring to FIG. 1, the system 10 includes a movable frame 18 having walls 14 extending therealong and a trolley 20 positioned on top of the movable frame 18 for receiving solid state materials. The system 10 further includes a self moving part, a pair of pusher rods 28 and a basket system incorporated to the trolley 20 and a movable frame 18 whose top surface is designed for placement of the trolley 20 and that is adapted for being positionable at a loading position. The system 10 is configured to load solid state materials quickly and efficiently by way of an automated roller-tracked bucket mechanism.

The trolley 20 and the movable frame 18 may be moved by way of electric motors. At least one electric motor 36 pushes the trolley 20, while the other (not shown) can be on any wheel of the frame. The self moving parts includes a first axle 26 and a second axle 32, in which the first axle 26 is coupled to a pair of traction wheels 22. The self moving parts may be operated by way of the electric motor 36. The electric motor 36 may be powered by way of electric current, batteries and the like. The electric current may be controlled by remote controllers. The pair of pusher rods 28 may include a tube welded together through a bar 48 for providing stability. The basket system includes a cradle 34. Preferably, the outer wall of the cradle tilts at approximately a 45 degree angle to facilitate the emptying of the cradle when tilted. The cradle 34 is welded or otherwise fixed to a second axle 32 via the cradle rods 34a. The pair of pusher rods 28 may be designed to interconnect the self moving part and the basket system by way of an axle bearing 30.

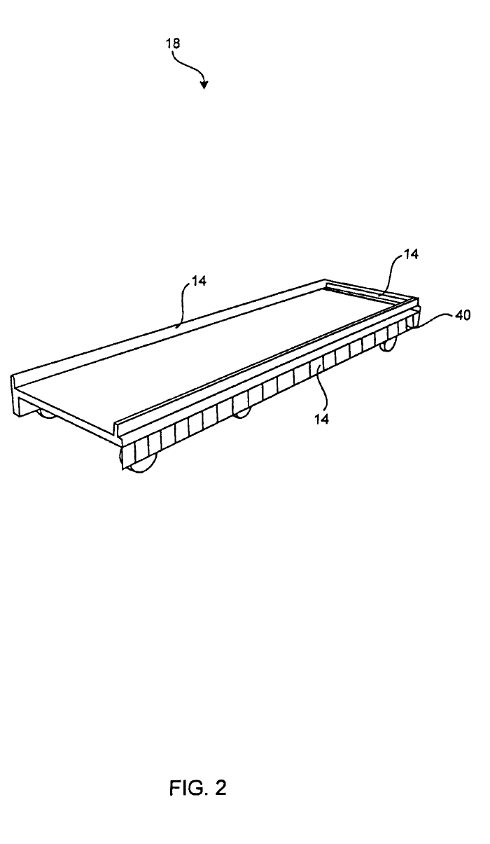

FIG. 2 illustrates a perspective view of the movable frame 18 having walls 14 extending therealong. The movable frame 18 has a built in measurement system 40 to identify how far the movable frame 18 has been inserted into the container. This measurement system 40 could be a ruler or position markings. This feature provides the positioning of the movable frame 18 within the trucking container to the exact point where the solid state materials can be unloaded. The motorized wheels can be operated by a radio controlled device.

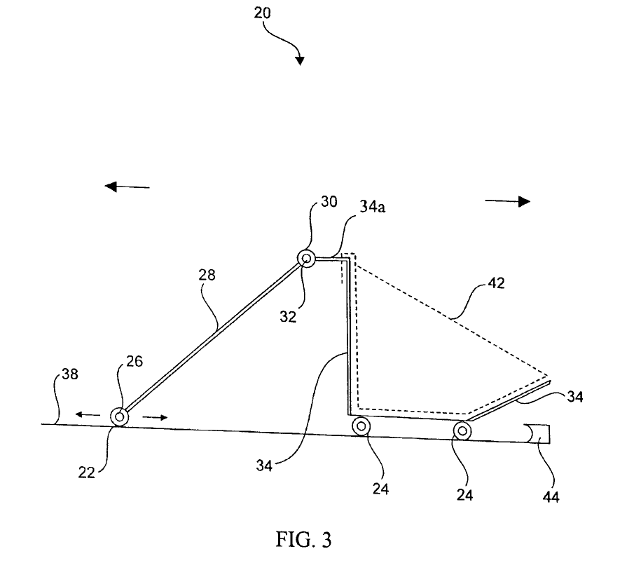

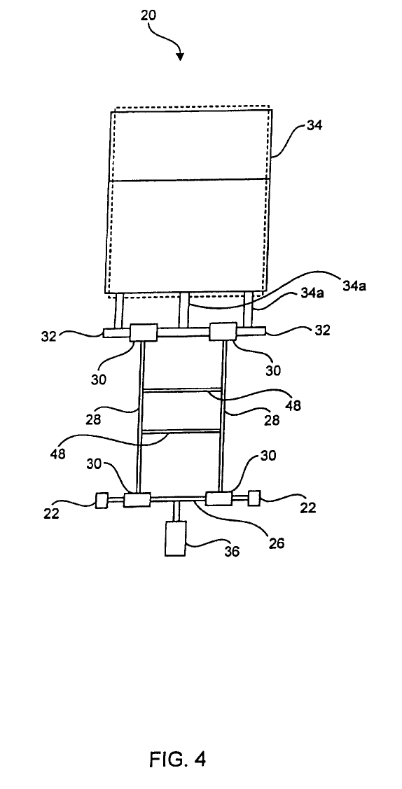

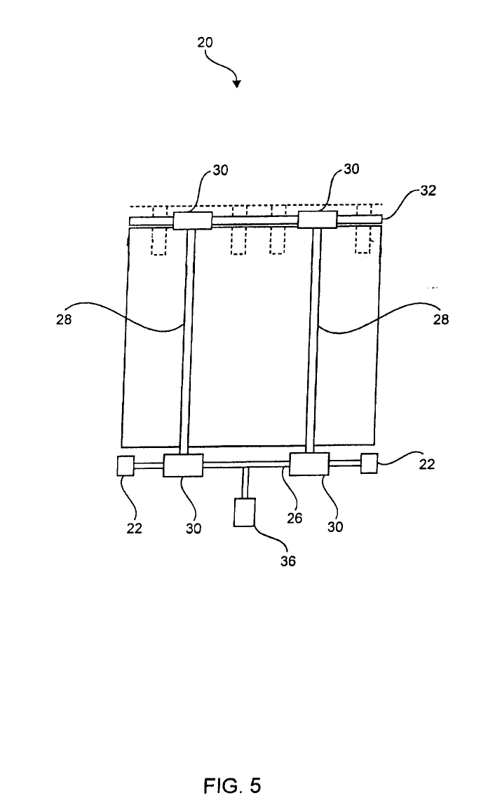

FIG. 3 illustrates a partial side sectional view of a trolley 20 designed for being placed on a movable frame 18. FIG. 4 illustrates a top plan view and partial sectional view of the movable trolley. FIG. 5 illustrates a top plan view and partial sectional view of the movable trolley in a folded position. Referring to FIGS. 3, 4 and 5, the trolley 20 and the movable frame 18 may be moved by way of an electric motor 36. The self moving parts includes a first axle 26 coupled to a pair of traction wheels 22 and movable fixed to axle bearings 30, and a second axle 32 movably fixed to axle bearings 30. The self moving parts may be operated by way of the electric motor 36. The electric motor 36 may be powered by way of electric current, batteries and the like. The electric current may be controlled by remote controllers. The pair of pusher rods 28 may include at least one tube welded together through a bar 48 for providing stability. The basket system includes a cradle 34 welded to a second axle 32 via cradle rods 34a. The cradle 34 includes a basket 42. The pair of pusher rods 28 may be designed to interconnect the self moving part and the basket system by way of an axle bearing 30. In FIG. 3, a wheel stop block 44 is utilized for restricting the movement of the wheels.

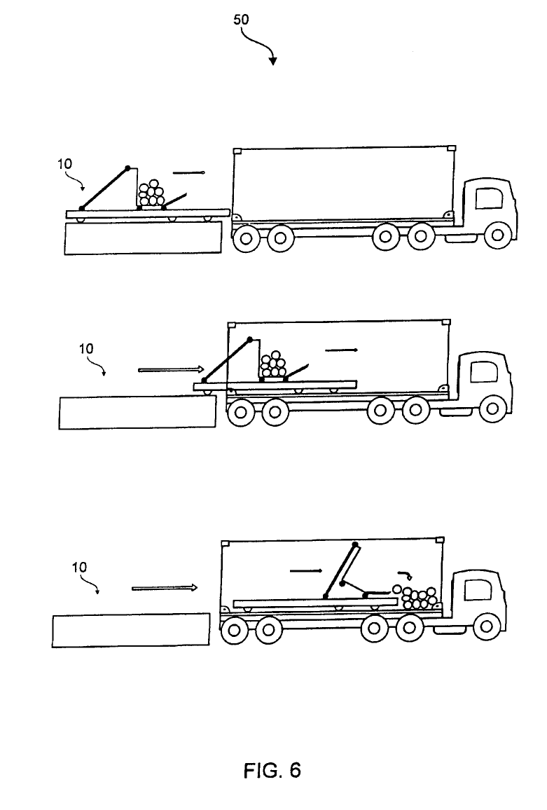

FIG. 6 shows a side view of the system 10 that illustrates a method 50 for loading solid state materials into containers. The loading system 10 is placed on a stable platform whose height can be elevated to match the back side of a truck container so that the loading system 10 can be rolled into the trucking or shipping container. Next, the cradle 34 is loaded with solid state materials, such as scrap metal, rocks, stones, bags filled with potatoes, etc, or a basket 42 is placed into the cradle 34 and the basket 42 is loaded with solid state materials. The loading system 10 is then rolled inside the trucking container. A user can roll the loading system 10 into a desired position within the trucking container to meet the weight distribution criteria of the department of transportation (DOT). When the loading system 10 is positioned in the desired location, the trolley 20 is moved forward, either manually by pushing the pusher rods 28 or by remote control, until the front cradle wheels 24 reach the wheel stop block 44 and the cradle 34 tilts forward so that the contents spill over into the desired location. Return the trolley 20 back to its stationery position and push it backwards so that it reaches the outside of the container for re-loading. If necessary, the entire loading system 10 can be moved backwards so that the trolley 20 is outside the container and the cradle 34 can be reloaded. The process is then repeated.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A system for loading solid state materials into a plurality of shipping, including trucking containers, the system comprising:
at least one movable frame having a plurality of walls extending therealong;
at least one trolley incorporated on top of the at least one movable frame for receiving solid state materials therein;
at least one self moving part,
a pair of pusher rods,
a basket system incorporated to the at least one movable trolley, and
a wheel stop block,
whereby the system is configured to load solid state materials quickly and efficiently by way of an automated roller-tracked bucket mechanism.

2. The system of claim 1, wherein the at least one trolley and the at least one frame comprises at least one wheel, respectively, and the least one trolley and the at least one frame are moved by way of at least one electric motor.

3. The system of claim 1, wherein the at least one self moving part includes at least one axle coupled to an axle bearings.

4. The system of claim 1, wherein the at least one self moving part includes at least one axle coupled to a pair of traction wheels.

5. The system of claim 4, wherein the at least one self moving part is operated by way of the at least one electric motor.

6. The system of claim 5, wherein the at least one electric motor is powered by way of electric current, batteries and the like.

7. The system of claim 6, wherein the electric current is controlled by remote controllers.

8. The system of claim 1, wherein the pair of pusher rods includes at least one tube welded together through at least one bar for providing stability.

9. The system of claim 1, wherein the basket system includes at least one cradle.

10. The system of claim 9, wherein the cradle is supported by at lease one wheel.

11. The system of claim 9, wherein the cradle comprises an outer wall tilted at approximately a 45 degree angle to facilitate the emptying of the cradle when tilted.

12. The system of claim 9, wherein the at least one cradle is welded to at least one axle.

13. The system of claim 1, wherein the pair of pusher rods is designed to interconnect the at least one self moving part and the basket system by way of at least one axle bearing.

14. A method for loading solid state materials into a plurality of shipping, including trucking containers, the method comprising the steps of:
(a) position the loading system on a stable platform whose height can be elevated to match the back side of a shipping or truck container so that the loading system can be rolled into the container;
(b) load solid state materials into a cradle of the loading system or insert a basket into the cradle and load the solid state materials into the basket;
(c) roll the loading system inside the shipping or truck container, either manually or by remote control;
(d) move a trolley of the loading system forward until it is stopped by a wheel stop block;
(e) continue moving the trolley forward until the cradle tilts forward and the contents of the cradle, or the contents of the basket, spills out; and
(f) return the trolley back to a stationery position and move it backwards for reloading.

15. The method of claim 14, wherein the steps (a) through (f) can be repeated.
